(19) United States
(12) Patent Application Publication
(10) Pub. No.: US 2017/0174850 A1
(43) Pub. Date: Jun. 22, 2017

(54) Composite fiber component and method for producing a composite fiber component

(71) Applicant: Brose Fahrzeugteile GmbH & Co. KG Patente/Lizenzen, Coburg (DE)

(72) Inventors: Jochen Hofmann, Markgraitz (DE); Ulf Hartmann, Schweinfurt (DE); Andrea Bauersachs, Ebersdorf (DE)

(21) Appl. No.: 15/129,700

(22) PCT Filed: Mar. 23, 2015
(86) PCT No.: PCT/EP2015/056045

§ 371 Date: Sep. 27, 2016

(30) Foreign Application Priority Data
Mar. 28, 2014 (DE) 10 2014 205 861.9

(51) Int. Cl. C08J 5/04; B29C 70/48; B29C 70/50

(52) U.S. Cl. CPC C08J 5/04; B29C 70/50; B29C 70/48

(57) ABSTRACT

The invention relates to a composite fiber component, having at least one layer of a fiber material, and a thermoplastic matrix, which the fiber material impregnates, wherein the composite fiber component has at least one first region in which the local degree of consolidation of the composite fiber component lies above a first consolidation threshold, and wherein the composite fiber component has at least one second region, lying adjacent to the first region, in which the local degree of consolidation of the composite fiber component lies under a second consolidation threshold, wherein the second consolidation threshold is smaller than the first consolidation threshold.

### CROSS-REFERENCE TO RELATED APPLICATION

This Application is a Section 371 National Stage Application of International Application No. PCT/EP2015/056045, filed 23 Mar. 2015 and published as WO 2015/144612 on 1 Oct. 2015, in German, the contents of which are hereby incorporated by reference in their entirety.

### TECHNICAL FIELD

The invention relates to a composite fiber component, in particular a fiber-fiber-reinforced thermoplastic component assembly, such as an organic sheet component, and to a method for producing such a composite fiber component, for example a fiber-reinforced thermoplastic component assembly.

### TECHNICAL BACKGROUND

A fiber-reinforced thermoplastic component assembly, such as an organic sheet component assembly, consists of a thermoplastic fiber-plastics composite.

Fiber-reinforced thermoplastics (FRT) are composite materials which consist of reinforcing fibers for load bearing and a matrix material for ensuring fiber orientation and dimensional stability. In the process, glass fibers, aramid fibers, carbon fibers, etc. or natural fibers such as sisal, coconut, hemp, flax, etc. can for example be used. Here, a distinction is made between short, long and continuous reinforcing fibers, short fibers and long fibers usually being injection-moulded or extruded directly using thermoplastic granules. Continuous reinforcing fibers are in turn generally processed as fiber strands, so-called rovings, knitted, woven or braided material. A thermoplastic material is used as the matrix material.

In order to produce continuously fiber reinforced thermoplastic components in profile form, the winding method, pultrusion method or interval hot pressing method, for example, can be used. Nowadays, flat components are produced by the thermoforming method using additional back injection or extrusion, for example in an injection moulding process. For this purpose, semi-finished products are generally used, which are supplied in the form of partly or fully pre-consolidated boards and are described as organic sheets or thermoplastic prepregs. Textile structures made from hybrid yarn, in which the matrix is also in fiber form as well as the reinforcing fibers, can be used as semi-finished products.

The published patent application WO 2012/032189 A2 discloses a method for producing a rear wall of a seat backrest for a seat backrest using at least one organic sheet. The published patent application DE 10 2012 104 044 A1 discloses a method for consolidating a thermoplastic preform, at least in regions, in a moulding tool. The published patent application DE 10 2011 056 686 A1 discloses a method for producing a composite fiber component.

### SUMMARY OF THE INVENTION

There is a need for solutions for the provision of composite fiber components which allow improved local force absorption and improved stiffness and strength properties.

Accordingly, a composite fiber component having the features of claim 1 and a method for producing a composite fiber component having the features of claim 11 are proposed.

According to a first aspect of the invention, a composite fiber component comprises at least one layer of a fiber material, and a thermoplastic matrix, which impregnates the fiber material, the composite fiber component having at least one first region in which the local degree of consolidation of the composite fiber component lies above a first consolidation threshold, and the composite fiber component having at least one second region, lying adjacent to the first region, in which the local degree of consolidation of the composite fiber component lies below a second consolidation threshold, the second consolidation threshold being lower than the first consolidation threshold.

According to a second aspect of the invention, a method for producing a composite fiber component includes consolidation of a first region of a fiber-reinforced semi-finished product with at least one layer of a fiber material and a thermoplastic matrix, which impregnates the fiber material, up to a first degree of consolidation, and consolidation of a second region, lying adjacent to the first region, of the fiber-reinforced semi-finished product up to a second degree of consolidation which differs from the first degree of consolidation, the second degree of consolidation being lower than the first degree of consolidation.

An essential concept of the invention is to influence differences in stiffness between various portions of a composite fiber component not or not only by means of a component geometry to be introduced or by means of the selection of the fiber material, but rather by means of undertaking a targeted local variation of the degree of consolidation or the degree of compaction of the composite fiber component in certain portions. As a result of an adjustment of the degree of consolidation, for example by setting different compaction pressures or compaction temperatures during the consolidation and/or impregnation of the fiber material with a thermoplastic matrix, the local stiffness and the local impact strength of the composite fiber component can be adjusted.

Advantageous technical effects of this procedure are the possibilities of forming zones of locally reduced impact strength, of improving the buckling behaviour, of forming zones of increased absorption of deformation energy and/or of improving the local introduction of force.

Advantageous embodiments and developments will emerge from the remaining dependent claims and from the description with reference to the figures in the drawings.

According to an embodiment of the composite fiber component according to the invention, the second consolidation threshold can be between 10% and 80% of the first consolidation threshold. As a result of the targeted setting of various degrees of consolidation, the acoustic behaviour, vibration absorption behaviour and impact strength of the composite fiber component can be influenced favourably.

According to another embodiment of the composite fiber component according to the invention, the second region can form a film hinge. This offers the advantage that in regions of the composite fiber component which are to be subjected to subsequent forming steps, such forming steps are simplified by the reduced degree of consolidation.

Furthermore, according to another embodiment of the composite fiber component according to the invention, the composite fiber component can have a force introduction region, the second region forming a circular or elliptical region around the force introduction region.

According to another embodiment of the composite fiber component according to the invention, the force introduction region can constitute a bonding point, a riveting point, a welding point, a screw connection point or a screw boss. Precisely in the regions of such force introduction points, a more even and more efficient force introduction into the composite fiber component is possible in an advantageous manner.

According to another embodiment of the composite fiber component according to the invention, the first region can have a first quantity of fiber layers and the second region can have a second quantity of fiber layers which is higher than the first quantity of fiber layers. Sudden increases in stiffness which emerge as a result of introducing local reinforcing fiber layers can be moderated particularly advantageously in this manner by the targeted formation of transition regions of incomplete consolidation.

Furthermore, according to another embodiment of the composite fiber component according to the invention, the composite fiber component can also have a third region, which has layers of the fiber material which is not impregnated by the thermoplastic matrix, the second region being arranged between the first region and the third region. Particularly in the case of multi-material combinations in which a composite fiber component runs over into a region of blank or non-impregnated fibers at the respective joints, a transition region between the fully consolidated region impregnated with matrix material and the region of non-impregnated fibers can be formed, which can improve the force introduction into the fibers in an advantageous manner.

According to another embodiment of the composite fiber component according to the invention, the fiber material can be formed from a fiber arrangement of glass fibers, aramid fibers, carbon fibers, sisal, hemp, coconut fibers, cotton fibers and/or flax, and the fiber arrangement can constitute a woven material, a fiber strand, a knitted material, a mesh, lattice, mat and/or non-woven material. In addition to the explicitly listed natural fibers, other natural fibers can likewise be used. Here, the fibers used can be short, long and/or continuous fibers.

According to another embodiment of the composite fiber component according to the invention, the composite fiber component can comprise at least one organic sheet or a pre-consolidated sheet, for example a Twintex® sheet. Such sheets have the advantage that the reinforcing fibers are already partially impregnated and consolidated, and therefore only a short processing time and relatively light pressure is required for forming. Additionally, it is no longer absolutely necessary to undertake a further consolidation for the pre-consolidated regions within the scope of the further processing of the organic sheets since these pre-consolidated regions already have a sufficient degree of partial consolidation, i.e. an incomplete consolidation to the desired extent.

According to another embodiment of the method according to the invention, the second degree of consolidation can be between 10% and 80% of the first degree of consolidation.

According to another embodiment of the method according to the invention, the consolidation of the first region can comprise an application of a first consolidation pressure to the fiber-reinforced semi-finished product, and the consolidation of the second region can comprise an application of a second consolidation pressure, which is lower than the first consolidation pressure, onto the fiber-reinforced semi-finished product.

The above embodiments and developments can be combined with one another as required, where appropriate. Further possible embodiments, developments and implementations of the invention also comprise combinations, which are not explicitly stated, of features of the invention referred to above or below in relation to the embodiments. In particular, the person skilled in the art will also add individual aspects as improvements or additions to the relevant basic form of the present invention in the process.

### BRIEF DESCRIPTION OF THE DRAWINGS

The present invention is described in more detail below with reference to the embodiments shown in the schematic figures of the drawings, in which:

FIG. 1 is a schematic illustration of a sectional view of a composite fiber component according to an embodiment of the invention;

FIG. 2 is a schematic illustration of plan views of a composite fiber component according to other embodiments of the invention;

FIG. 3 is a schematic illustration of a sectional view and a plan view of a composite fiber component according to another embodiment of the invention;

FIG. 4 is a schematic illustration of a sectional view of a composite fiber component according to another embodiment of the invention;

FIG. 5 is a schematic illustration of a sectional view of a composite fiber component according to another embodiment of the invention;

FIG. 6 is a schematic illustration of a sectional view of a composite fiber component according to another embodiment of the invention;

FIG. 7 is a schematic illustration of a sectional view of a composite fiber component according to another embodiment of the invention; and

FIG. 8 is a block diagram of a process sequence for producing a composite fiber component according to another embodiment of the invention.

The accompanying drawings are intended to provide further understanding of the embodiments of the invention. They illustrate embodiments and serve to explain principles and concepts of the invention in conjunction with the description. Other embodiments and many of the described advantages will emerge with respect to the drawings. The elements in the drawings are not necessarily shown to scale relative to one another.

Elements, features and components which are the same, have the same function and have the same effect are each given the same reference numerals in the drawings—unless stated explicitly to the contrary.

### DETAILED DESCRIPTION OF EMBODIMENTS

FIG. 1 is a schematic illustration of a sectional view through a composite fiber component 1. Here, the composite fiber component 1 can in particular be a fiber-reinforced thermoplastic component. For reasons of simplicity, the term composite fiber component is used synonymously hereinafter for a fiber-reinforced thermoplastic component. The composite fiber component 1 can comprise a fiber-reinforced semi-finished product, for example an organic sheet, which comprises a fiber arrangement of one or more layers of a fiber material, which are embedded in a thermoplastic matrix material, for example a plastic matrix material, or are impregnated by the same. By using the thermoplastic matrix material, the composite fiber component 1 is thermally formable.

The fiber material can, for example, comprise a fiber arrangement in the form of a woven material, a fiber strand, a knitted material, a mesh, lattice, mat and/or non-woven material. Here, the lattices can be multiaxial lattices or unidirectional lattices. Furthermore, the fibers of the fiber material can be short, long and/or continuous fibers. The composite fiber component 1 can, for example, comprise Twintex®. Here, reinforcing fibers, such as glass fibers, are processed with thermoplastic fibers, for example polypropylene, to make rovings; these are interwoven and subsequently heated up and formed under pressure into a semi-finished product.

The fiber material of the fibers used in the composite fiber component 1 can, for example, be glass fibers, aramid fibers, carbon fibers, sisal, hemp, coconut fibers, cotton fibers and/or flax. Here, the fibers can extend at right angles to one another depending on the required mechanical properties of the composite fiber component 1 as regards stiffness, strength and thermal expansion. The embodiments of the composite fiber components disclosed herein are not restricted to the fiber materials mentioned and the fiber processing forms mentioned such as woven material, non-woven material, knitted material or similar. Here, the composite fiber component 1 can be provided in its initial form as a flat semi-finished product or as a formed structural component.

The composite fiber component 1 in FIG. 1 comprises at least one layer 2 of a fiber material, which is impregnated by a thermoplastic matrix 3. The thermoplastic matrix 3 can, for example, comprise thermoplastics, such as acrylonitrile butadiene styrene (ABS), polyamide (PA), polyetherimide (PEI), polylactide (PLA), polymethyl methacrylate (PMMA), polycarbonate (PC), polyethylene terephthalate (PET), polyethylene (PE), polypropylene (PP), polystyrene (PS), polyether ether ketone (PEEK), polypropylene sulphide (PPS) or polyvinyl chloride (PVC).

The composite fiber component 1 has two regions 4 and 5, which are located adjacent to one another, i.e. are either spaced apart from one another or extend adjacently to one another. The regions 4 and 5 differ from one another essentially by their local degree of consolidation, i.e. the degree of compaction and strength which the component achieves in this component zone following the application of pressure and heat. As a result of the consolidation, the fiber material 2 is impregnated with the matrix material 3 and compressed. As a result of the compression, air or gas pockets can be removed from the fiber composite. Hereinafter the respective borders between first and second regions are illustrated by B1 and B2 and with dash-dotted lines. Here, however, it should be clear that the border lines between first and second regions are not necessarily distinctly clear and intermediate regions may lie between respective first and second regions with essentially constantly changing degrees of consolidation.

In the first region 4, the local degree of consolidation of the composite fiber component 1 lies above a first consolidation threshold value, while the local degree of consolidation of the composite fiber component 1 in the second region 5 lies below a second consolidation threshold. Here, the second consolidation threshold value is in particular lower than the first consolidation threshold value such that a full or nearly full consolidation can be referred to in the first region 4, and an incomplete or partial consolidation can be referred to in the second region 5. For example, the second consolidation threshold value can be set at approximately between 10% and 80% of the first consolidation threshold value. As a result, the adhesion between the fiber material and the matrix material can be adjusted selectively.

The composite fiber component 1 in FIG. 1 can, for example, be used to form a film hinge in the second region 5. Film hinges and film joints are strap hinges, which are designed as flexible and thin-walled articulated grooves between two portions of a composite fiber component to be connected. Moreover, the proportion of matrix material in the second region 5 can be reduced in order to simplify forming steps in the second region 5, for example folding or bending of the composite fiber component 1 in the second region 5.

FIG. 2 is a schematic illustration of a plan view of a composite fiber component 1, in order to explain the geometric design possibilities for the second region 5 by way of example. Here, a composite fiber component 1 can have just one or some of the second regions 5 shown by way of example in FIG. 2. The quantity of the second regions 5 and the possible combinations of different regional geometries for the second regions 5 are generally unlimited in this case and can be selected according to the desired stiffness relationships in the composite fiber component 1.

On the far left in FIG. 2, strip-shaped second regions 5 are shown, which are interrupted by first regions 4 of a higher degree of consolidation. As a result, the acoustic behaviour of the composite fiber component 1 can, for example, be improved due to elastic deformations. Moreover, the vibration and damping behaviour can be improved by such second regions 5.

In the centre and on the right in FIG. 2, the degree of consolidation is reduced in meandering or local regions 5 in order, for example, to create regions with increased impact strength in the event of plastic deformations of the composite fiber component 1 and to be able to absorb deformation energy better in the component.

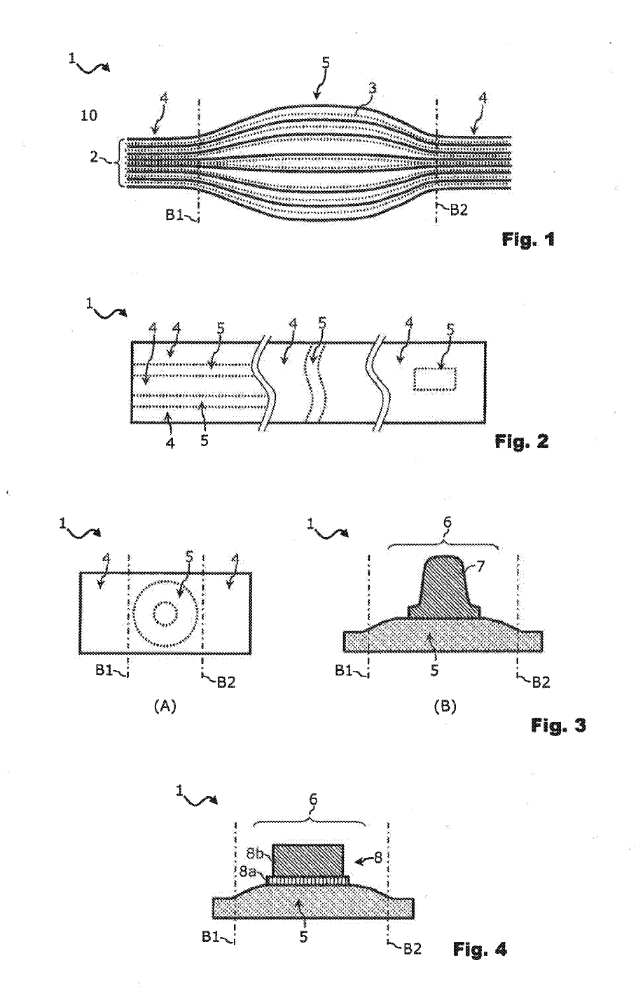

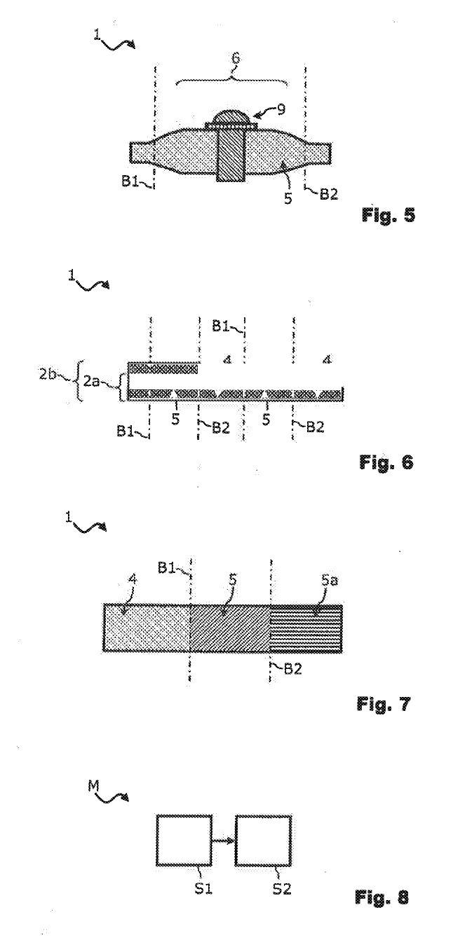

The second regions 5 of reduced or incomplete consolidation are particularly suited to use in force introduction regions of composite fiber components, three examples of which are shown in FIG. 3, FIG. 4 and FIG. 5. FIG. 3 is a schematic illustration of a plan view (A) of a composite fiber component 1 with a force introduction region 6, which is located inside a second region 5 of a reduced degree of consolidation. Here, the second region 4 constitutes a circular or elliptical region around the force introduction region 6. As shown in the sectional view (B) of the composite fiber component 1 of the view (A), a screw boss 7 is formed on the force introduction region 6 and allows a gentler force introduction into the composite fiber component 1 as a result of the reduced degree of consolidation in the second region 5. Moreover, the screw boss 7 is consequently better protected against overload.

FIG. 4 is a sectional view of a composite fiber component 1 with a force introduction region 6 which is located inside a second region 5 of a reduced degree of consolidation. The force introduction region 6 in FIG. 4 is a bonding point 8, at which point a bonding partner 8b is attached to the composite fiber component 1 using a bonding medium 8a. As a result of the second region 5 of a reduced degree of consolidation, the surface of the composite fiber component 1 is enlarged such that the bonding medium 8a gains an improved reaction surface. Moreover, as a result of the reduced degree of consolidation in the second region 5, a gentler force introduction into the composite fiber component 1 is facilitated in the region of the bonding point 8.

FIG. 5 is a sectional view of a composite fiber component 1 comprising a force introduction region 6 which is located inside a second region 5 of a reduced degree of consolidation. The force introduction region 6 in FIG. 5 is a screw connection point 9 at which point a screw connection is introduced into the composite fiber component 1. As a result of the second region 5 of a reduced degree of consolidation, the available component thickness of the composite fiber component 1 is increased locally such that a better force introduction is possible in the region of the screw connection point 9. Moreover, as a result of the reduced degree of consolidation in the second region 5, a gentler force introduction into the composite fiber component 1 is facilitated in the region of the screw connection point 9.

In a similar way to FIG. 4 and FIG. 5, riveting points or welding points can also be formed. In the case of welding points, the advantage also emerges that continuous fibers can be pushed into the welding zone in a targeted manner in the incompletely consolidated regions 5.

FIG. 6 is a schematic view of a composite fiber component 1 which comprises different quantities of fiber layers 2 in a direction of extension. From right to left, for example, the quantity of layers increases in order to be able to create local reinforcing layers. In each zone in which a new reinforcing layer begins, the stiffness of the whole composite fiber component 1 suddenly increases locally. In order to reduce the extent of the sudden increase in stiffness, a first region 4 can be formed in a zone with a first quantity of fiber layers 2a. This first region 4 is directly adjacent to a second region 5 which comprises a second quantity of fiber layers 2b, which is higher than the first quantity of fiber layers 2a. If the second region 5 now comprises a locally reduced degree of consolidation in comparison to the first region, the stiffness of the composite fiber component 1 only increases gradually, as a result of which the rise in stiffness extends more smoothly across the whole composite fiber component 1. Moreover, the stress concentration factor or notch effect between the individual layer transitions is reduced.

FIG. 7 is a schematic illustration of a plan view of a composite fiber component 1 which has no matrix material 3, i.e. blank, non-impregnated or non-wetted fibers, in a third region 5a, for example an end portion of the composite fiber component 1. Said third region 5a can be adjacent to a second region 5 of a reduced degree of consolidation, the second region 5 being arranged between the first region 4 and the third region 5a. Such third regions 5a are, for example, used at joints of composite fiber components which are connected to other joint partners in the region of the blank fibers by bonding. An optimal force introduction into the fibers can be ensured by the gradual reduction of the degree of consolidation from the first region 4, through the second region 5 and to the third region 5a.

The composite fiber components shown in FIG. 1 to FIG. 7 can, for example, be produced by means of an injection mould of an injection moulding tool for injecting thermoplastic materials. In the process, an organic sheet or a pre-consolidated sheet, for example a Twintex® sheet or a stack of layers of such sheets can for example be used, and said sheets can be heated as a semi-finished product or pre-formed component up to the processing temperature of the plastics matrix and laid into the injection mould of the injection moulding tool. In the case of thin-walled composite fiber components, the heating can also take place in the injection mould.

The semi-finished product or pre-formed component accommodated in the injection mould is heated up to an appropriate processing temperature such that likewise appropriately heated fluid thermoplastic matrix material can be injected into the injection mould. In the process, the injected matrix material can, for example, be the same material as the matrix material 3 of an organic sheet that is used. Alternatively, a different thermoplastic material can also be injected, which can combine with the thermoplastic matrix material 3 of the semi-finished product or pre-formed component.

Instead of an injection moulding tool, an extrusion tool or another suitable tool can be used. The invention is, however, not limited to injection moulding and extrusion.

FIG. 8 is a block diagram of a method M for producing a composite fiber part, for example one of the composite fiber parts 1 shown in any of FIG. 1 to FIG. 7. The method M can be used within the scope of an injection moulding or extrusion process. In a first step S1, consolidation of a first region 4 of a fiber-reinforced semi-finished product, for example an organic sheet or a stack of organic sheets takes place with at least one layer 2 of a fiber material and a thermoplastic matrix 3, which impregnates the fiber material. This consolidation is carried out up to a first degree of consolidation. Simultaneously or consecutively, a consolidation of a second region 5 of the fiber-reinforced semi-finished product, which is located adjacent to the first region 4, i.e. is spaced apart from or adjacently to the first region 4, takes place in step 2 up to a second degree of consolidation that is different from the first degree of consolidation. Here, the second degree of consolidation is lower than the first degree of consolidation, such that the second region 5 is not fully consolidated in relation to the first region 4, i.e. is not hardened and compacted to the same extent as the first region 4. For example, the second degree of consolidation can be between 10% and 80% of the first degree of consolidation.

The differing consolidation in steps S1 and S2 can, for example, be achieved by a first consolidation pressure being applied to the fiber-reinforced semi-finished product in the first region 4 which is higher than a second consolidation pressure, which is applied in the second region 5 to the fiber-reinforced semi-finished product. Alternatively or additionally, the length of time during which a consolidation pressure is applied to the second region 5 can also be reduced in comparison with the length of time during which a consolidation pressure is applied to the first region 5 in order to achieve the different degrees of consolidation. Ultimately, it is also possible to reduce the proportion of the matrix material in the second region 5 in comparison with the first region 4 in order to allow the lower degree of consolidation in the second region 5.

Although the present invention has been described in full above with reference to preferred embodiments, it is not restricted thereto, but can be modified in various ways. In particular, individual features of embodiments described separately above can also be combined with one another, unless otherwise stated explicitly.

### LIST OF REFERENCE NUMERALS

1 Composite fiber component
2 Fiber layer
2a Fiber layers
2b Fiber layers
3 Thermoplastic matrix
4 First region
5 Second region
5a Third region
6 Force introduction region
7 Screw boss
8 Bonding point
8a Bonding medium
8b Bonding partner
9 Screw connection point
B1 Border between regions
B2 Border between regions
M Method
S1 Method step
S2 Method step

1. A composite fiber component, comprising:
at least one layer of a fiber material; and
a thermoplastic matrix, which impregnates the fiber material,
wherein the composite fiber component has at least one first region in which the local degree of consolidation of the composite fiber component lies above a first consolidation threshold, and
wherein the composite fiber component has at least one second region, lying adjacent to the first region, in which the local degree of consolidation of the composite fiber component lies below a second consolidation threshold,
wherein the second consolidation threshold is lower than the first consolidation threshold.

2. The composite fiber component according to claim 1, wherein the second consolidation threshold is between 10% and 80% of the first consolidation threshold.

3. The composite fiber component according to claim 1, wherein the second region constitutes a film hinge.

4. The composite fiber component according to claim 1, further comprising:
a force introduction region,
wherein the second region constitutes a circular or elliptical region around the force introduction region.

5. The composite fiber component according to claim 4, wherein the force introduction region constitutes a bonding point, a riveting point, a welding point, a screw connection point or a screw boss.

6. The composite fiber component according to claim 1, wherein the first region has a first quantity of fiber layers and
wherein the second region has a second quantity of fiber layers which is higher than the first quantity of fiber layers.

7. The composite fiber component according to claim 1, further comprising a third region, which has layers of fiber material not impregnated by the thermoplastic matrix,
wherein the second region is arranged between the first region and the third region.

8. The composite fiber component according to claim 1, wherein the fiber material is formed from a fiber arrangement of glass fibers, aramid fibers, carbon fibers, sisal, hemp, coconut fibers, cotton fibers and/or flax, and
wherein the fiber arrangement is a woven material, a fiber strand, a knitted material, a mesh, lattice, mat and/or a non-woven material.

9. The composite fiber component according to claim 1, wherein the composite fiber component is a continuous fiber-reinforced composite fiber component.

10. The composite fiber component according to claim 1, wherein the composite fiber component has at least one organic sheet or a pre-consolidated sheet, for example a Twintex® sheet.

11. A method for producing a composite fiber component, comprising:
consolidation of a first region of a fiber-reinforced semi-finished product with at least one layer of a fiber material and a thermoplastic matrix, which impregnates the fiber material, up to a first degree of consolidation; and
consolidation of a second region of the fiber-reinforced semi-finished product, which lies adjacent to the first region, up to a degree of consolidation which is different to the first degree of consolidation,
wherein the second degree of consolidation is lower than the first degree of consolidation.

12. The method according to claim 11, wherein the second degree of consolidation is between 10% and 80% of the first degree of consolidation.

13. The method according to claim 11, wherein the consolidation of the first region comprises an application of a first consolidation pressure to the fiber-reinforced semi-finished product, and the consolidation of the second region comprises an application of a second consolidation pressure, which is lower than the first consolidation pressure, to the fiber-reinforced semi-finished product.
